(19) United States
(12) Patent Application Publication
(10) Pub. No.: US 2009/0240543 A1
(43) Pub. Date: Sep. 24, 2009

(54) PROJECT TROUBLE OCCURRENCE PREDICTION SYSTEM, METHOD AND PROGRAM

(76) Inventors: Taiga Nakamura, Kanagawa (JP); Akiko Suzuki, Kawasaki-shi (JP)

Correspondence Address: IBM CORPORATION, T.J. WATSON RESEARCH CENTER, P.O. BOX 218, YORKTOWN HEIGHTS, NY, 10598, US

(21) Appl. No.: 12/407,809

(22) Filed: Mar. 20, 2009

(30) Foreign Application Priority Data
Mar. 21, 2008 (JP) 200873565

(51) Int. Cl. G06Q 10/00; G06N 5/02

(52) U.S. Cl. 705/7; 706/52

(57) ABSTRACT

Based on expression patterns describing project information, a trouble occurrence probability and time are estimated by using a project trouble occurrence probability distribution in which a point where the expression pattern appears in a text of the project in formation is set as a reference, and by using statistics representing the distribution. With high likelihood, projects likely to have a trouble are narrowed down. The project information is a project state report regularly created for each project and includes at least a text describing the project state and information indicating the case where the project falls into a troubled state. The expression pattern is one or more definition descriptions that each specifies a specific linguistic expression in natural language processing. Expression pattern characteristics include a project trouble occurrence probability distribution in which a point where a certain expression pattern appears in a text of the project information is set as a reference, and statistics representing the distribution.

### CROSS REFERENCE TO RELATED APPLICATIONS

This application claims priority under 35 U.S.C. §119 from Japanese Patent Application number 2008-73565, filed on Mar. 21, 2008, the entire contents of which are incorporated herein by reference.

### BACKGROUND OF THE INVENTION

The present invention relates to a technology for predicting trouble occurrence in project management for software development, product development and the like.

In project management for software development and the like, it is very important to recognize troubles as early as possible. A delay in recognition of troubles makes it more difficult to take measures or leads to extra cost and work. In typical project progress management, a project leader regularly reports project information and a supervisor evaluates a project state based on the information. Since the supervisor is generally required to manage a large number of projects, it is difficult for him/her to take time and examine all reports. Thus, in actual project progress management, the supervisor recognizes occurrence of troubles by checking if the project has a problem based on predetermined objective criteria, i.e., by checking if there is a schedule delay, a cost overrun or the like, for example. Thus, the report is checked by going over standard check items and scored as a result of the checking. These measures are useful for surely recognizing an actual trouble after occurrence thereof, but are not effective for earlier recognition of troubles. Furthermore, in general, there is a psychological tendency for project leaders to avoid notifying his/her supervisor of troubles. Thus, the troubles are often not recognized by the supervisor until the very last minute.

Meanwhile, the report of the project information often includes text information described in natural language to complement the standard check items as described above. A skilled project manager is said to be able to predict whether or not troubles are likely to occur in the future, based on text contents and characteristics of expressions by reading the text information. For a project likely to have a trouble, such a trouble can be prevented or measures can be taken early by carefully checking the project beforehand. Thus, the text information is very useful. However, as the number of projects increases, trouble prediction becomes difficult since a person has a limit to reading all texts with his/her eyes.

Therefore, it has been desired to automatically analyze the text information in the project progress management and to narrow down the projects to those that are likely to have a trouble based on the analyzed information.

Japanese Patent Application Publication No. Hei 10(1998)-240715 relates to a method for predicting and estimating new problems from a plurality of cases including quantitative attributes. To be more specific, for example, in the case of estimating “quality characteristics” from a set of “design attribute values” of a product, the following steps are disclosed, including: (1) obtaining similarity of the design attribute values between each of the cases and the new problem; (2) selecting the cases having high similarity to the new problem and obtaining a predicted distribution of the quality characteristics for each of the cases; and (3) obtaining a final predicted value by synthesizing a plurality of the predicted distributions thus obtained.

Japanese Patent Application Publication No. 2004-252893 relates to a method for measuring operational risks. Particularly, the method is intended to improve the validity and stability of a risk value when an amount of loss is estimated from the past records. To be more specific, there is disclosed a specific smoothing method for a transaction amount distribution to be used for the estimation.

Japanese Patent Application Publication No. 2005-018304 relates to a time-series data prediction method and discloses methods including: (1) dividing time-series data to be used for prediction into subsets; (2) creating a value frequency distribution histogram for each of the subsets; and (3) obtaining a predicted value based on a cumulative frequency of the histogram corresponding to attributes of a prediction target from a group of the histograms.

Japanese Patent Application Publication No. 2005-157755 relates to a system for recording medical accidents and discloses methods of recording, as internal factors, personal attributes of a person who reports and judges the accidents in addition to recording the accidents. Particularly, it is disclosed that internal values in the personal attributes are extracted as factors by analyzing report descriptions of accident records through language analysis.

However, none of the above conventional technologies makes it possible with sufficient reliability to automatically analyze the text information in the project progress management and to narrow down the projects to one likely to have a trouble based on the analyzed information.

### SUMMARY OF THE INVENTION

It is an object of the present invention to provide a technique for recognizing occurrence of troubles early with high likelihood in project management.

It is another object of the present invention is provide a technique for making it possible with sufficient reliability to automatically analyze text information in project progress management and to narrow down projects to one likely to have a trouble based on the analyzed information.

In order to achieve the foregoing objects, the present invention preferably has the following configuration.
1. An expression pattern management part which manages a set of expression patterns to be used for project trouble prediction
2. A text analysis part which analyzes a text included in project information and outputs the expression patterns appearing in the text among the specified expression patterns
3. A pattern characteristic calculation part which calculates characteristics of the expression patterns based on past project information and appearing expression patterns
4. An output part which outputs a project trouble warning by use of the appearing expression patterns and the expression pattern characteristics.

In the above description, particularly, the project information is a project state report regularly created for each project and includes at least a text describing the project state and, if the project falls into a troubled state, information indicating that state. The expression pattern is one or more definition descriptions that specify a specific linguistic expression in natural language processing. Moreover, the expression pattern characteristics include a project trouble occurrence probability distribution, in which a point of time when a certain expression pattern appears on a text in the project information is set as an origin, and statistics representing the distribution.

### BRIEF DESCRIPTION OF THE DRAWINGS

For a more complete understanding of the present invention and the advantage thereof, reference is now made to the following description taken in conjunction with the accompanying drawings.

FIG. 1 is a schematic block diagram of hardware for implementing the present invention.

FIG. 2 is a schematic block diagram of a logical configuration for implementing the present invention.

FIG. 3 is a graph showing an example of expression pattern characteristics.

FIG. 4 is a flowchart showing processing of representing a number of troubles observed as a time-series histogram.

FIG. 5 is a flowchart showing the processing of representing the number of troubles observed as the time-series histogram.

FIG. 6 is a flowchart showing the processing of representing the number of troubles observed as the time-series histogram.

FIG. 7 is a flowchart showing the processing of representing the number of troubles observed as the time-series histogram.

FIG. 8 is a flowchart showing processing of selecting expression patterns useful for prediction from the expression pattern characteristics.

FIG. 9 shows a screen for selecting the expression patterns.

FIG. 10 is a flowchart showing processing of predicting a troubled project.

FIG. 11 shows a screen of a project trouble prediction view.

FIG. 12 shows a cumulative histogram display of the expression patterns.

### DETAILED DESCRIPTION OF THE INVENTION

With reference to the drawings, a configuration and processing according to an embodiment of the present invention will be described below. In the following description, unless otherwise noted, the same components are denoted by the same reference numerals throughout the drawings. Note that the configuration and processing described here is only one example of the embodiment and there is no intention to limit the technical scope of the present invention to this specific embodiment.

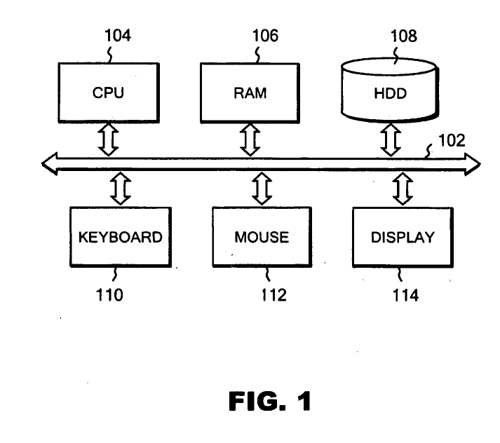

FIG. 1 shows a block diagram of computer hardware for carrying out a system configuration and processing according to the embodiment of the present invention. In FIG. 1, a CPU 104, a main memory (RAM) 106, a hard disk drive (HDD) 108, a keyboard 110, a mouse 112 and a display 114 are connected to a system bus 102. The CPU 104 is preferably based on a 32-bit or 64-bit architecture, and for example Pentium (trademark) 4 and Core (trademark) 2 DUO by Intel Corporation, Athlon (trademark) by AMD, Inc. or the like can be used. The main memory 106 preferably has a capacity of 2 GB or more. The hard disk drive 108 preferably has a capacity of 200 GB or more.

Although not individually shown, in advance, the hard disk drive 108 stores an operating system, past project information, current project information to be analyzed and processing programs according to the present invention.

The operating system may be an arbitrary one compatible with the CPU 104, such as Linux (trademark), Windows (trademark) Vista, Windows XP (trademark) and Windows (trademark) 2000 by Microsoft Corporation and Mac OS (trademark) by Apple Computer.

Moreover, the hard disk drive 108 may also store an arbitrary programming language processor such as C, C++, C# and Java (trademark). This programming language processor is used to create and retain processing programs according to the present invention.

The hard disk drive 108 may further include a text editor for writing source codes to be compiled by the programming language processor and a development environment such as Eclipse (trademark).

The keyboard 110 and the mouse 112 are used to initiate the operating system or a program (not shown), which are loaded into the main memory 106 from the hard disk drive 108 and displayed on the display 114, and to type characters.

The display 114 is preferably a liquid crystal display, and one having an arbitrary resolution, such as XGA (1024×768 resolution) and UXGA (1600×1200 resolution), can be used. The display 114 is used to display a result of processing according to the present invention.

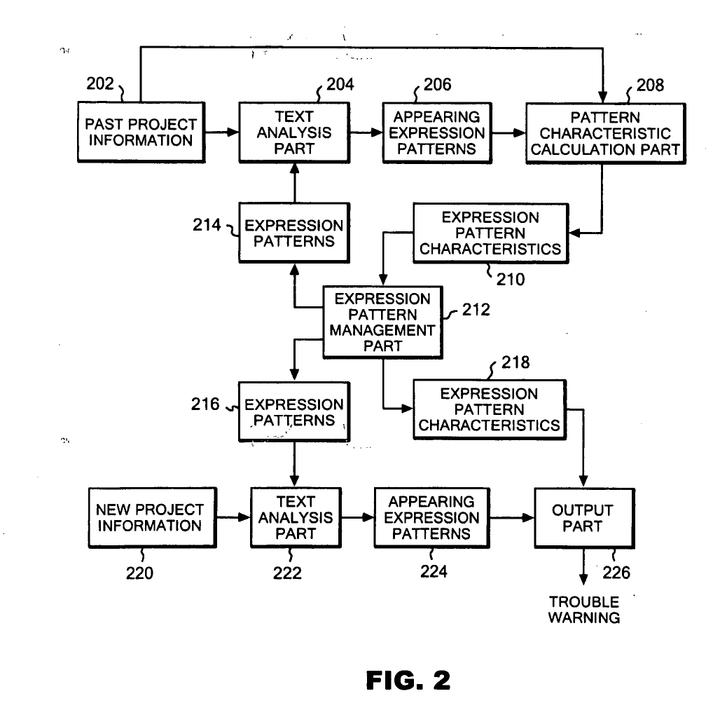

Next, a processing flow according to the present invention will be schematically described with reference to a functional block diagram shown in FIG. 2. Each of functions of logical blocks 204, 208, 212, 222, 224 and 226 shown in FIG. 2 is created, as a part of a single module or an individual module, by use of an appropriate programming language such as C, C++, C# and Java (trademark). Each of the logical blocks is stored in the hard disk drive 108, and is loaded into the main memory 106 by a function of the operating system according to need so as to be executed.

In FIG. 2, past project information 202 includes at least project IDs of past projects and a text notifying a state of each project or trouble information on the past projects, and time and date of notification. The past project information 202 is stored in a computer-readable form, such as CSV and XML, in the hard disk drive 108.

A text analysis part 204 has a function of performing morphological analysis and syntactic analysis on a given text by use of a publicly known text analysis technique, though not limited to, such as one described in Japanese Patent Application Publication Nos. Hei 6(1994)-325104, 2000-76274 and 2004-126933. And then the text analysis part 204 determines whether or not the specified expression patterns are in the text and outputs a frequency thereof. To perform such determination, the text analysis part 204 receives expression patterns 214 from an expression pattern management part 212.

Thereafter, the text analysis part 204 outputs appearing expression patterns 206 in the following form.

TABLE 1

| | Time and date | | |
|---|---|---|---|
| | of | Expression | Observation |
| Project ID | notification | pattern | count |
| 1001 | 2007/11/1 | patternA | 3 |
| 1001 | 2007/12/1 | patternB | 2 |
| 1002 | . . . | | |

This table-form listing expression patterns 206 is stored in the computer-readable form such as CSV and XML, for example, in the hard disk drive 108. This processing is performed for all the stored past project information 202 and a result of the processing serves as the appearing expression patterns 206. Here, the appearing expression patterns 206 are, for example, a pattern indicating occurrence of trouble, such as “okyaku-sama . . . chousei-suru” (The customer makes an adjustment to . . . ) and “keikaku henkou . . . hassei-suru” (a plan change occurs).

In the context of this embodiment, the expression pattern means a set of definitional descriptions of linguistic expressions which specify the above specific linguistic expressions that are obtained as a result of natural language processing. For example, each linguistic expression definitional description includes the following.

### Specific Word:

(Example) specific word specified by use of a dictionary
Concrete Example: “risuku (risk)”

### Specific Modifier-Modifiee Pattern:

(Example)
“(noun)→(case particle)→(verb)” (A→B denoting A is modifying B)
Concrete Example: “jikan→ga→kakaru (a time is required)”

### Bigram or Trigram of Specific Word Class or Character String:

(Example) two consecutive or three consecutive nouns and the like
Concrete Example: (noun) (case particle) “okyaku:sama (customer: Mr./Ms.)”

### Specific Word Class:

(Example) adverbs, onomatopoeias (imitative words and mimetic words) and the like
Concrete Example: “mada-mada (not yet)” “giri-giri (to the maximum extent possible)”

Each of the expression patterns is a group of more than one of those linguistic expression definitions described above. If a certain text contains any of the linguistic expression definitional descriptions that belong to the expression pattern, the text is regarded to match the expression pattern.

The form in which the linguistic expression definitions and the expression patterns are described is arbitrary. For example, in a form that can be used as an input to IBM OAE (OmniFind Analytics Edition), the linguistic expression definitions and the expression patterns are expressed as follows by use of XML.

```
<mi category=
          ”exp_patternA” value=”${n1.lex}.${a1.lex}...${1.lex}”>
  <w id=”1” pos=”/\hat{ }((noun)|(verb)|(adjective))$/”
  ftrs=”!/\hat{ }((pron)|(suffix)|(formal_n)|(rt))$/”>
    <w id=”a1” pos=”adposition”>
      <w id=”n1” lex=”/\hat{ }(risuku)$/”/>
      </w>
  </w>
</mi>
```

A pattern characteristic calculation part 208 calculates characteristics of each expression pattern with respect to project trouble occurrence, based on data, and outputs the calculated characteristics as expression pattern characteristics 210. An input to the pattern characteristic calculation part 208 includes the appearing expression patterns and a list of dates when trouble occurrence is recognized for those troubles that have already occurred and is stored in the past project information 202. The following table shows an example of the list.

TABLE 2

| | Date when trouble |
|---|---|
| | occurrence is |
| Project ID | recognized |
| 1002 | 2008/1/13 |
| 1008 | 2007/6/11 |
| . . . | . . . |

Here, information in Table 2 shows only the date when the trouble occurrence is recognized. But information on time may also be included as a matter of course.

By use of those described above, pattern characteristics are calculated as follows.
1. A set of expression patterns appearing in Table 1 described above is obtained and set as E.
2. The following calculation is performed for each of expression patterns e belonging to E.

a. Only rows related to the expression pattern e in Table 1 are selected. Thereafter, a total sum of appearance counts of those rows is obtained and set as c.

b. With reference to Table 2, whether or not a project trouble has occurred is checked based on the project ID for each of the selected rows. If the project trouble has occurred, a relative time T is obtained, which is defined by the following equation.

T=(time and date when trouble occurrence is recognized)−(time and date of notification)

Thereafter, for the expression pattern e, (T, (observation count)/c) is recorded. Particularly, the second term (observation count)/c is called a normalized observation count.

c. A list of (T, normalized observation count) thus obtained is characteristics of the expression pattern e.

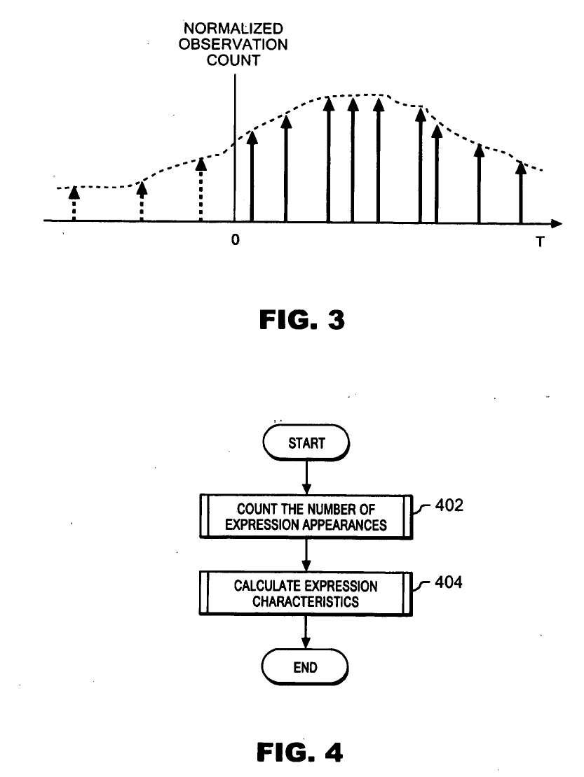

Note that FIG. 3 shows conceptual illustration of the expression pattern characteristics. In FIG. 3, the graph on the side where T is positive can be interpreted as a graph showing a probability of project trouble occurrence being observed when the time T has passed since observation of the expression pattern, based on data. In other words, a probability of trouble occurrence being observed at the time T after observation of the expression pattern is calculated by the following formula.

$${\sum }_{( 0 , T )} ( normalized observation count ) \qquad [ Formula 1 ]$$

For later description, this probability is expressed as Prob[trouble|e](T).
3. Furthermore, effectiveness of the expression pattern is calculated based on the expression pattern characteristics described above. As the definition of effectiveness, any of the following can be used.
a. A proportion by which the expression pattern can contribute to trouble detection:

$${\sum }_{T > 0} ( normalized observation count ) ; \qquad [ Formula 2 ]$$

b. How far into the future the expression pattern can contribute to trouble prediction : average of the normalized observation count over T
c. How stable trouble time prediction is obtained from the expression pattern : variance of the normalized observation count over T
   Alternatively, overall effectiveness can also be defined by combining those described above.

An output from the pattern characteristic calculation part is a group containing the list (T, normalized observation counts) indicating the characteristics of each expression pattern and a value of effectiveness.

Note that, as the definition of T, instead of using the above mentioned relative time directly, a progress rate of the project can also be used, the progress rate being obtained by dividing the relative time by a length of each project. In this case, T is defined as follows.

T={(time and date when the trouble occurrence is recognized)−(time and date of notification)}/(length of project)

Moreover, in the case where large volumes of data and various kinds and properties exist in the past project information, the above processing can also be performed for each of the kinds and properties of the projects. In this case, characteristics of each of the expression patterns are calculated for each of the kinds and properties of those projects.

The expression pattern management part 212 manages a set of expression patterns together with characteristic information of the expression patterns. The expression pattern characteristic information is as described above in connection with the pattern characteristic calculation part 208.

The operations of the expression pattern management part 212 are as follows.
1. First, all candidates for expression patterns to be used are stored in a table. These candidates may be randomly generated or expressions considered to be likely to be useful for project trouble prediction may be directly defined and used. Moreover, the past project information may be subjected to text processing, as preprocessing, and patterns may be defined based on linguistic expressions contained therein. For example, all the linguistic expressions contained may be used or the expressions may be narrowed down to frequently-appearing expressions and used.
2. A list (all candidates) of expression patterns is provided to the text analysis part 204 for processing of the past project information.
3. Characteristic information on each of the expression patterns is received from the pattern characteristic calculation part 208 and stored in the table.
4. For project trouble prediction, the list of the expression patterns is provided to the text analysis part. Here, all the candidates of expression patterns may be provided or, based on the characteristic information, only those useful for trouble prediction may be provided. In the latter case, for example, patterns having higher effectiveness (to be described later) can be selected.
   Moreover, information on pattern characteristics corresponding to the expression patterns handed over to the text analysis part 204 is provided to an output part 226 which will be described later.

New project information 220 is data on a project to be subjected to trouble prediction. A data format of the new project information 220 preferably includes a project ID of a new project, a text notifying a state of the project and time and date of notification.

As a text analysis part 222, the text analysis part 204 may be used as it is or one that is different from the text analysis part 204 and has approximately the same function may be used. The text analysis part 222 also performs analysis by use of expression patterns 216 provided by the expression pattern management part 212.

As in the case of the text analysis part 204, the text analysis part 222 generates appearing expression patterns 224. The appearing expression patterns 224 are provided to the output part 226.

The following are specific contents of processing executed by the output part 226.
1. The expression patterns 224 (input from the text analysis part 222) matching target project information are sorted in descending order of effectiveness. If there are many expression patterns, the following processing may be performed by using only those having higher effectiveness (if all the expression patterns are always used, there is no need for sorting in the order of effectiveness). Among the matching expression patterns, a set of the expression patterns to be subjected to the following processing is set as E′=(e₁, e₂, . . . e_{L}) (L is the number of expression patterns).
2. As described above, for each expression pattern eᵢ (i=1, 2, . . . , L), expression pattern characteristics 218, in other words, a probability Prob[trouble|ei](T) of trouble observation within T after the observation of the expression pattern is obtained. The output part 226 checks probability values for eᵢ (i=1, 2, . . . , L) and lists those having probabilities exceeding a certain threshold to issue a trouble warning.
3. Alternatively, as another method, assuming that each of the expression patterns appears independently, a probability Prob[trouble|E′](T) of trouble observation within T after observation of E′=(e₁, e₂, . . . e_{L}) is approximately estimated as follows.

$$Prob [ trouble \vert {E}^{′} ] ( T ) \approx \{ {\prod }_{i} Prob [ {e}_{i} \vert trouble ] ( T ) \} \cdot \{ \frac{Prob [ trouble ]}{Prob [ {E}^{′} ]} \} \qquad [ Formula 3 ]$$

By use of the above, an estimated trouble probability within the time T can be outputted.

The output part 226 performs the above processing for each of target projects and outputs the projects after sorting the projects in descending order of trouble occurrence probability.

Next, with reference to flowcharts shown in FIGS. 4 to 7, description will be given of processing of calculating characteristics of each of expression patterns (a histogram of trouble observation patterns). This processing is performed by the pattern characteristic calculation part 208 shown in FIG. 2.

FIG. 4 is a high-level flowchart showing the processing of calculating the characteristics of each of the expression patterns. Generally, the processing includes Step 402 of counting the number of expression appearances and subsequent Step 404 of calculating characteristics of the expressions.

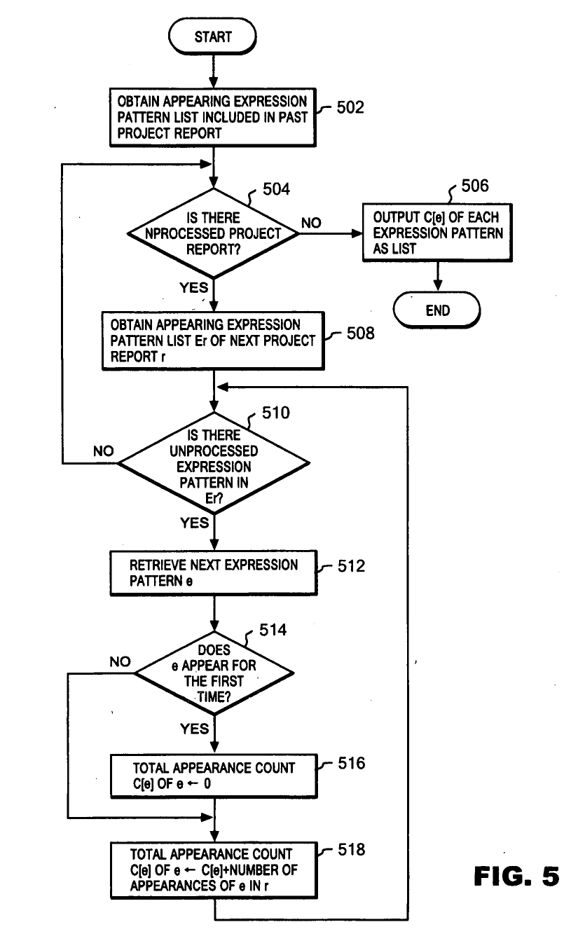

FIG. 5 is a more detailed flowchart of processing in Step 402 of counting the number of expression appearances. With reference to FIG. 5, in Step 502, an appearance expression pattern list included in a past project report is obtained. The past project report is included in the past project information 202 shown in FIG. 2.

In Step 504, it is determined whether or not there is an unprocessed project report. If the processing of all the project reports is completed, the result of the determination is No. Thus, in Step 506, a total appearance count C[e] of each expression pattern is outputted as a list. Thereafter, the processing is terminated.

If it is determined in Step 504 that there is an unprocessed project report, an expression pattern list Er of a next project report r is obtained in Step 508. Thereafter, in Step 510, it is determined whether or not there is an unprocessed expression pattern in the expression pattern list Er. If it is determined in Step 510 that all the expression patterns in the expression pattern list Er are processed, the processing returns to the determination in Step 504.

If it is determined in Step 510 that there is still an unprocessed expression pattern in the expression pattern list Er, a next expression pattern e is taken out in Step 512.

In Step 514, it is determined whether or not the expression pattern e appears for the first time. If so, in Step 516 the total appearance count C[e] of the expression pattern e is initialized to 0.

Next, in Step 518, the total appearance count C[e] of the expression pattern e is incremented by the number of appearances of e in the expression pattern list Er. Thereafter, the processing returns to the determination in Step 510.

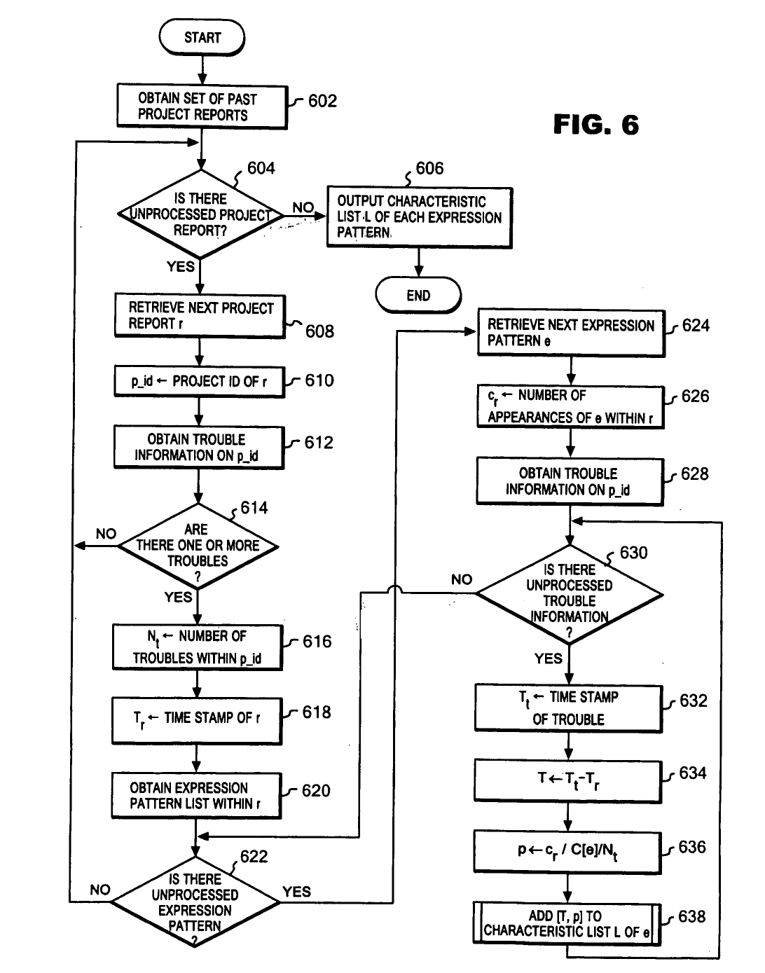

FIG. 6 is a more detailed flowchart of processing in Step 404 of calculating characteristics of the expressions in FIG. 4. With reference to FIG. 6, in Step 602, the appearance information pattern list included in the past project report is obtained. The past project report is included in the past project information 202 shown in FIG. 2.

In Step 604, it is determined whether or not there is an unprocessed project report. If the processing of all the project reports is completed, the result of the determination is No. Thus, in Step 606, a characteristic list of each expression pattern is outputted. Thereafter, the processing is terminated.

If it is determined in Step 604 that there is the unprocessed project report, a next project report r is obtained in Step 608.

In Step 610, a project ID of the project report r is set to p_id.

In Step 612, trouble information on p_id is obtained. Thereafter, in Step 614, it is determined whether or not there are one or more troubles in the trouble information.

If it is determined in Step 614 that there are one or more troubles in the trouble information, the number of troubles of p_id is set to Nₜ in Step 616.

If it is determined in Step 614 that there is no trouble in the trouble information, the processing returns to Step 604.

If it is determined in Step 614 that there are one or more troubles in the trouble information, a time stamp of the project report r is set to Tᵣ in Step 618 subsequent to Step 616.

In Step 620, an expression pattern list within the project report r is obtained. Thereafter, in Step 622, it is determined whether or not there is an unprocessed expression pattern. If there is no more unprocessed expression pattern, the processing returns to Step 604.

If it is determined in Step 622 that there is the unprocessed expression pattern, a next expression pattern e is taken out in Step 624.

In Step 626, the number of appearances of the expression pattern e within the project report r is stored in cᵣ.

In Step 628, trouble information on p_id is obtained. Thereafter, in Step 630, it is determined whether or not there is unprocessed trouble information.

If it is determined in Step 630 that there is no more unprocessed trouble information, the processing returns to Step 622.

If it is determined in Step 630 that there is still unprocessed trouble information, a time stamp of the trouble information is stored in Tₜ in Step 632. Thereafter, in Step 634, Tₜ−Tᵣ is assigned to T.

In Step 636, cᵣ/C[e]/Nₜ is assigned to p.

In Step 638, a subroutine 638 of adding [T, p] to the characteristic list L of the expression pattern e is executed. Thereafter, the processing returns to Step 630.

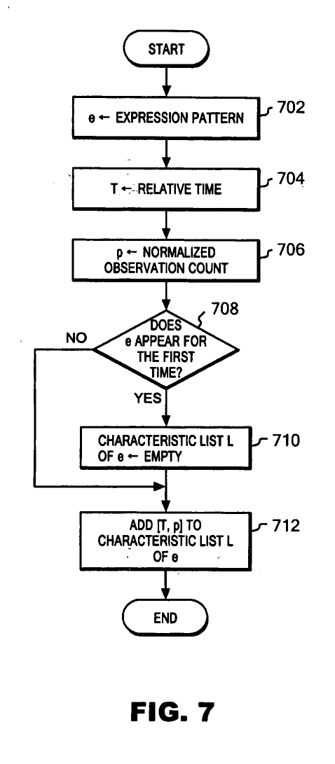

FIG. 7 is a flowchart showing processing in the subroutine 638 shown in FIG. 6. In Step 702 shown in FIG. 7, an expression pattern is set to e. In Step 704, relative time is set to T. The relative time here is Tₜ−Tᵣ in Step 634 shown in FIG. 6.

In Step 706, a normalized count is set to p. The normalized count here is cᵣ/C[e]/Nₜ in Step 636.

In Step 708, it is determined whether or not the expression pattern e appears for the first time. If so, the characteristic list L of the expression pattern e is emptied in Step 710.

Next, in Step 712, [T, p] is added to the characteristic list L of the expression pattern e.

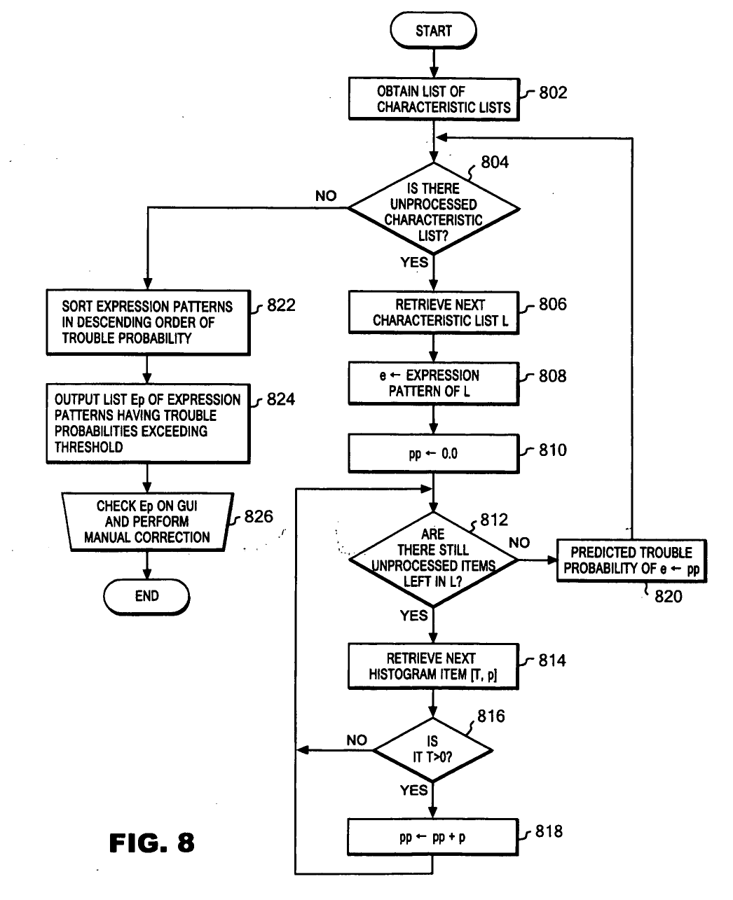

Next, with reference to a flowchart of FIG. 8, description will be given of a processing of selecting an expression pattern useful for prediction. This processing is executed by the expression pattern management part 212 shown in FIG. 2.

In Step 802 shown in FIG. 8, a list of characteristic lists is obtained. Thereafter, in Step 804, it is determined whether or not there is an unprocessed characteristic list. If so, a next characteristic list is taken out in Step 806.

In Step 808, an expression pattern of a characteristic list L is set to e.

In Step 810, 0.0 is set to a floating-point number pp. Thereafter, in Step 812, it is determined whether or not there are still unprocessed items left in the characteristic list L. If so, a next histogram item [T, p] is taken out from the characteristic list L in Step 814.

In Step 816, it is determined whether or not a value of T in the taken out histogram item [T, p] is larger than 0. If not T>0, the item is not useful for the purpose of this processing. Thus, the processing immediately returns to Step 812.

If T>0, p is added to pp in Step 818. Thereafter, the processing returns to Step 812.

If it is determined in Step 812 that there is no more unprocessed item in the characteristic list L, pp, as a trouble probability of the expression pattern e, is assigned in Step 820. Thereafter, the processing returns to Step 804.

If it is determined, back in Step 804, that there is no more unprocessed characteristic list, the processing advances to Step 822 where the expression patterns are sorted in descending order of the trouble probability.

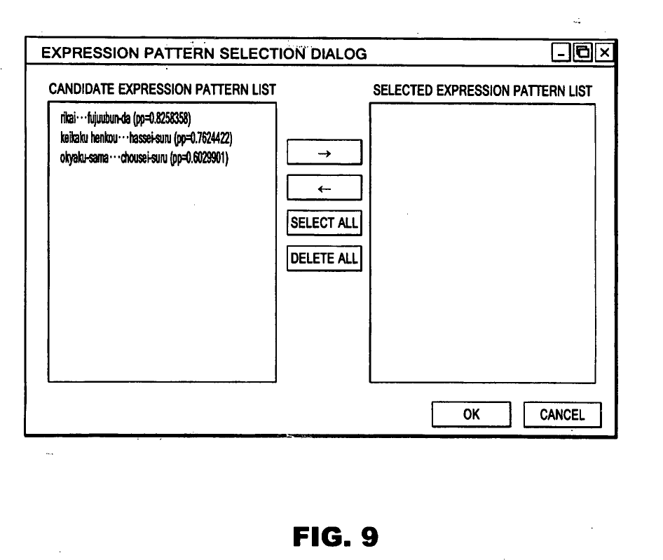

In Step 824, a list Eₚ of the expression patterns having trouble probabilities exceeding a threshold is outputted. In Step 826, a user performs selection of which one of the expression patterns is to be actually used and the like by checking the list Eₚ with a GUI of the display 114. FIG. 9 shows an example of such a GUI.

Specifically, in FIG. 9, the result of the processing in Step 824 is listed in a “candidate expression pattern list”. Thus, by clicking on a candidate expression pattern with the mouse 112 and then clicking on a button “→” or by clicking on a button “Select All”, the candidate expression pattern can be moved to a “selected expression pattern list” and used for subsequent processing. The expression pattern thus selected is provided, as the expression pattern characteristics 218 shown in FIG. 2, to the output part 226.

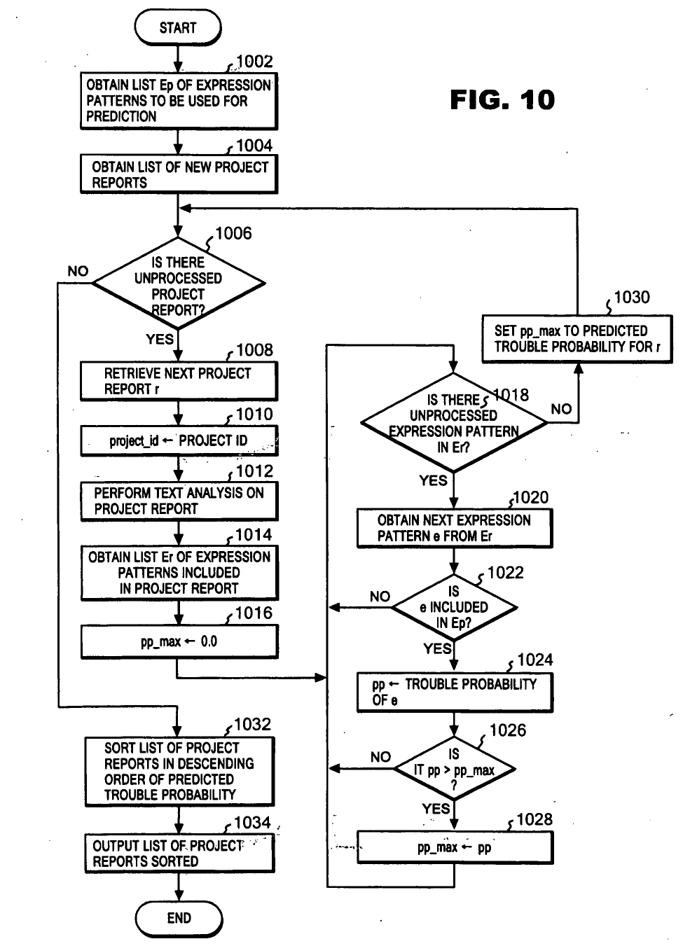

Next, with reference to FIG. 10, description will be given of processing of predicting troubled project. This processing is executed by the output part 226 shown in FIG. 2.

In Step 1002 shown in FIG. 10, a list Eₚ of expression patterns to be used for prediction is obtained from the expression pattern management part 212. In Step 1004, a list of new project reports is obtained. This is displayed as new project information 220 and stored in a predetermined data format in the hard disk drive 108.

In Step 1006, it is determined whether or not there is an unprocessed project report in the list of the new project reports. If there is the unprocessed project report, a next project report r is retrieved in Step 1008.

Next, in Step 1010, a project ID of the project report r is assigned to a variable project_id. Thereafter, in Step 1012, a text of the project report is subjected to syntactic analysis. This processing is executed by the text analysis part 222 shown in FIG. 2. Moreover, this processing may be the same as that described in connection with the text analysis part 204 shown in FIG. 2. Furthermore, the text analysis part 222 may refer to the expression patterns 216 provided by the expression pattern management part 212 and extract only the patterns therein.

Thus, in Step 1014, a list Eᵣ of the expression patterns included in the project report r is obtained.

Next, in Step 1016, 0.0 is assigned to a variable pp_max. Thereafter, in Step 1018, it is determined whether or not there is an unprocessed pattern in Eᵣ. If there is the unprocessed pattern, the processing advances to Step 1020 where a next expression pattern e is obtained from Eᵣ.

In Step 1022, it is determined whether or not the expression pattern e is included in Eₚ. Here, Eₚ means the expression pattern characteristics 218 provided by the expression pattern management part 212. It can also be said that Eₚ is one selected as the selected expression pattern list in FIG. 9.

If the determination in Step 1022 is negative, the processing returns to Step 1018. On the other hand, if it is determined in Step 1022 that the expression pattern e is included in Eₚ, a trouble probability of the expression pattern e is assigned to a variable pp. As can be seen from FIG. 9, since a predicted trouble probability is associated with Eₚ as a result of the processing shown in the flowchart of FIG. 8, the trouble probability of the expression pattern e can be obtained.

In Step 1026, it is determined whether or not pp thus obtained is larger than pp_max. If pp is larger than pp_max, the maximum value pp_max is updated by assigning a value of pp to pp_max in Step 1028. Thereafter, the processing returns to Step 1018. On the other hand, if pp is not larger than pp_max, the processing directly returns to Step 1018.

Thereafter, if it is determined in Step 1018 that there is no more unprocessed pattern in Eᵣ, pp_max is set to the predicted trouble probability for the project report r in Step 1030. Subsequently, the processing returns to Step 1006.

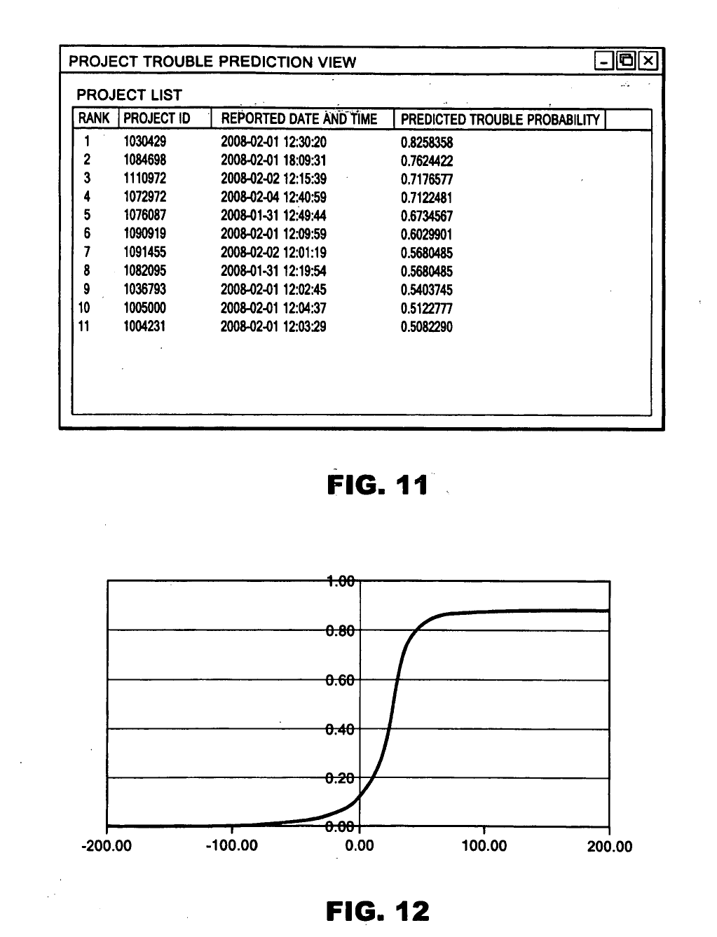

If it is determined in Step 1006 that there is no more unprocessed project report, the list of the project reports is sorted in descending order of predicted trouble probability in Step 1032. Thereafter, in Step 1034, the list of the project reports sorted is preferably outputted and displayed on the display 114. FIG. 11 shows an example of such a list display.

Next, description will be given of a concrete example of the past project report and processing associated therewith.

It is assumed that there is the following past project report.
Project ID 000012
Report ID R100039
Reported Date and Time: May 1, 2007 14:30:14
Name of Client: XXX Corporation
Project Leader's Comment:

(In Japanese) Tsugi no tsuki ikou no keiyaku ni tsuite okyaku-sama to chousei-shita. Sarani, okyaku-sama kara souteigai no gaibu sekkei kikan enchou no hanashi ga ari, tsuika shien keiyaku nai de jisshi suru koto de goui. Yoki senu purojekuto keikaku henkou ga hassei shita. Shanai ni okeru keiyaku no chousei ga hitsuyou de aru. Mata, kokyaku manzokudo chousa ni okeru hyouka no teika mo houkoku sareta. Okyaku-sama ni taishite mo shinchou na taiou ga hitsuyou de aru.

(An adjustment has been made with the client for the contract from next month. There was an unexpected suggestion by the client for extension of the term of the external design, and implementation within the additional support contract was agreed upon. An unexpected project plan change has occurred. An in-house adjustment for the contract is required. Moreover, a drop in the rating in the customer satisfaction survey was also reported. A careful handling is required to communicate with the client.)
Cost Overrun: Yes
Overdue: Yes

The following table shows appearance counts of the expression patterns extracted by the text analysis processing. Note that, here, the table shows the case where “noun . . . verb” and “noun . . . adjective verb” forms among “subject . . . predicate” forms (in Japanese) are used as the expression patterns. There are the following two methods to carry out the present invention, including: a method for extracting the expression patterns by specifying a modification pattern as described here; and a method for manually creating a specific expression set beforehand as a dictionary and extracting items which match with the dictionary.

TABLE 3

| | | | | Appear- |
|---|---|---|---|---|
| Project | Report | | | ance |
| ID | ID | Time Stamp | Expression Pattern | Count |
| 000012 | R100039 | 2007-05-01 | “hanashi . . . aru (there | 1 |
| | | 14:30:14 | be . . . suggestion)” | |
| 000012 | R100039 | 2007-05-01 | “okyaku-sama . . . | 1 |
| | | 14:30:14 | chousei-suru | |
| | | | (client . . . adjustment)” | |
| 000012 | R100039 | 2007-05-01 | “teika . . . houkoku-suru | 1 |
| | | 14:30:14 | (report . . . drop)” | |
| 000012 | R100039 | 2007-05-01 | “keiyaku . . . chousei-suru | 1 |
| | | 14:30:14 | (adjust . . . contract)” | |
| 000012 | R100039 | 2007-05-01 | “chousei . . . hitsuyou-da | 1 |
| | | 14:30:14 | (require . . . adjustment)” | |
| 000012 | R100039 | 2007-05-01 | “taiou . . . hitsuyou-da | 1 |
| | | 14:30:14 | (require . . . handling)” | |
| 000012 | R100039 | 2007-05-01 | “keikaku | 1 |
| | | 14:30:14 | henkou . . . hassei-suru | |
| | | | (plan change . . . | |
| | | | occur)” | |

Each of the past reports is similarly analyzed and added to the above table to obtain a past project information set.

Next, description will be given of an example of expression pattern characteristics.

The expression pattern characteristics are represented by a list of [T, p]. For example, expression pattern characteristics calculated for the expression pattern “keikaku henkou . . . hassei-suru” are sorted in ascending order of T. The following table shows the result. In this table, the third column shows a cumulative value of p (a sum of a cumulative value of p up to the previous row (0 in the case of the first row) and p in the current row).

TABLE 4

| T (days) | P | Cumulative Value of p |
|---|---|---|
| −108.8097 | 0.000281 | 0.000281 |
| −91.48014 | 4.02E−05 | 0.000321 |
| −87.49828 | 0.000141 | 0.000462 |
| −84.39161 | 0.000141 | 0.000603 |
| −81.29019 | 0.000141 | 0.000743 |
| . . . | . . . | . . . |
| −0.035059 | 0.000562 | 0.116946 |
| −0.001895 | 0.000281 | 0.117227 |
| 194.3809 | 4.02E−05 | 0.879388 |

Specifically, if the above expression pattern appears in the report, the project is a troubled project by the probability of 87.9% (0.879388) based on the total cumulative value. Furthermore, based on the cumulative value in the portion of T>0, a trouble occurs after the point when the expression pattern appears in the report, by the probability of 76.2% (pp=0.879388−0.116946=0.762442). Therefore, it is found out that the larger the value of pp, the more useful the expression pattern is for trouble prediction.

FIG. 12 shows expression pattern characteristics on a cumulative histogram (a graph plotted by setting T as the horizontal axis and the cumulative value of p as the vertical axis)

Next, description will be given of an example of a result of prediction by applying an appearance pattern of a past project.

The following is an example of a new project report to be a target for trouble prediction.
Project ID 1084698
Reported Date and Time: Feb. 1, 2008 18:09:31
Name of Client: YYY Corporation
Project Leader's Comment:

(In Japanese) Shanai tetsuzuki de keiyaku shounin made sunda ga, sono go okyaku-sama tsugou ni yori 11/1 kaishi ni henkou. Sagyou naiyou no naibu chousei chuu. Jitsu-keiyaku ni mukete okyaku-sama to hibi chousei chuu. Genzai okure to naru youin ha miukerarenai ga, ikutsuka no keikaku henkou ga hassei shite iru. Sonotame, kongetsu ni haitte kara suudo, sagyou sukejyu-ru wo okyaku-sama to chousei shita. Sono kekka shidai deha, kongo henkou ga hassei uru kanousei ga aru. Kongo mo chuui ga hituyou to kangaete iru.

(The internal procedures have been completed up to the approval of the contract. However after that the starting date was changed to November 1 due to the client's request. Internal adjustments are being made for work details. Adjustments are being made on a daily basis with the client for the actual contract. Currently, there is no factor to cause delay but several plan changes have occurred. Thus, in this month, adjustments were made with the client for the work schedule several times. Depending on the result of the adjustments, a plan change may arise. It is necessary to continue to exercise caution.)
Cost Overrun: No
Overdue: Yes

The following are expression patterns which are extracted by the text analysis and used for trouble prediction.

TABLE 5

| Project | Report | | | |
|---|---|---|---|---|
| ID | ID | Time Stamp | Expression Pattern | pp |
| 1084698 | R300395 | 2008-02-01 | “okyaku-sama . . . | 0.6029901 |
| | | 18:09:31 | chousei-suru | |
| | | | (client . . . | |
| | | | adjustment)” | |
| 1084698 | R300395 | 2008-02-01 | “keikaku | 0.7624422 |
| | | 18:09:31 | henkou . . . | |
| | | | hassei-suru (plan | |
| | | | change . . . occur)” | |

With reference to Table 5, the maximum value of pp obtained from this report is pp_max=0.7624422 (in the case of “keikaku henkou . . . hassei-suru”).

Similarly, the above processing is performed for each of new reports on other projects to obtain pp_max. Thereafter, the projects are sorted in descending order of pp_max. The following table shows the result.

TABLE 6

| Project ID | Time Stamp | pp_max |
|---|---|---|
| 1030429 | 2008-02-01 12:30:20 | 0.8258358 |
| 1084698 | 2008-02-01 18:09:31 | 0.7624422 |
| 1110972 | 2008-02-02 12:15:39 | 0.7176577 |
| 1072934 | 2008-02-04 12:40:59 | 0.7122481 |
| 1076087 | 2008-01-31 12:49:44 | 0.6734567 |
| 1090919 | 2008-02-01 12:09:59 | 0.6029901 |
| 1091455 | 2008-02-02 12:01:19 | 0.5680485 |
| 1082095 | 2008-01-31 12:19:45 | 0.5680485 |
| 1036793 | 2008-02-01 12:02:45 | 0.5403745 |
| 1005000 | 2008-02-01 12:04:37 | 0.5122777 |
| 1004231 | 2008-02-01 12:03:29 | 0.508229 |
| . . . | . . . | . . . |

This is the order of project trouble occurrence probabilities obtained according to the present invention. Based on information indicating that the project ranked higher in the list has a higher trouble probability, the user can perform thorough checks on project situations preferentially from above (for example, the project 1084698 in the project report example described above has the second priority here). Thus, early detection and prevention of troubles can be efficiently achieved.

Although the present invention has been described above based on the specific embodiment, the embodiment is only one of the examples of the present invention. Therefore, those skilled in the art in the field can come up with various modified examples without departing from the scope of the invention. For example, in the block diagram shown in FIG. 2, the past project information is subjected to syntactic analysis to obtain expression patterns for predicting troubles in new projects. However, if the new projects are typical ones, there is no need to perform syntactic analysis on the past project information, before every prediction for the new projects. Instead, database storing the syntactically-analyzed past project information may be used directly for predicting troubles in these new projects.

Moreover, for example, in the block diagram shown in FIG. 2, when the past project information and the new project information are used, all the project information that can be used are used without considering a classification of the projects, such as the kind, time and size. However, by previously classifying the project information into categories and performing the processing shown in FIG. 2 for each of the categories, expression patterns different according to the project classification can be used for trouble prediction.

According to the present invention, based on the expression pattern describing the project information, trouble occurrence probability and time can be estimated by use of the project trouble occurrence probability distribution, in which a point of time when the expression pattern appears on a text in the project information is set as an origin, and statistics representing the distribution. Thus, with high likelihood that has not heretofore been possible, the projects likely to have a trouble can be narrowed down.

Although the preferred embodiment of the present invention has been described in detail, it should be understood that various changes, substitutions and alternations can be made therein without departing from spirit and scope of the inventions as defined by the appended claims.

What is claimed is:

1. A system for estimating a trouble occurrence probability in a project, the system comprising:
a data storage part configured to:
store a plurality of past expression patterns; and
store corresponding past trouble occurrence probabilities data for the plurality of past expression patterns;
a text analysis part configured to:
extract a plurality of expression patterns by performing syntactic analysis on a text describing a state of the project whose trouble occurrence is to be predicted; and
a prediction part configured to:
match each of the past expression patterns with each expression pattern selected from the plurality of expression patterns extracted from the text describing the state of the project; and
predict the trouble occurrence probability of the project in response to matching the past expression patterns and the expression patterns, by use of the past trouble occurrence probabilities.

2. The system according to claim 1, wherein:
the plurality of past expression patterns is retrieved by performing syntactic analysis on text describing states of a plurality of past projects; and
the plurality of corresponding past trouble occurrence probabilities is calculated by statistically processing time when a trouble occurs in each of the past projects and a frequency of the past expression pattern associated with the trouble.

3. The system according to claim 2, wherein the plurality of past trouble occurrence probabilities is calculated by use of a cumulative histogram of trouble occurrences, the cumulative histogram being normalized over the trouble occurrences in the past projects, and trouble occurrence time for each of the past expression patterns.

4. The system according to claim 3, wherein the prediction part is configured to predict the trouble occurrence probability of the project by determining an accumulation starting point of the cumulative histogram, based on starting time of the project as a target for prediction of the trouble occurrence.

5. The system according to claim 1, wherein the prediction part is configured to predict the trouble occurrence probability of the project by use of the largest past trouble occurrence probability selected from the set of past trouble occurrence probabilities associated with the matched past expression patterns.

6. A method for estimating a trouble occurrence probability in a project, the method comprising:
retrieving a plurality of past expression patterns associated with trouble occurrence by performing syntactic analysis on text describing states of a plurality of past projects;
storing the plurality of past expression patterns;
recording the trouble occurrences in a time-series manner based on the states of the plurality of past projects, for each of the past expression patterns;
extracting a plurality of expression patterns by performing syntactic analysis on a text describing a state of the project as a target for trouble occurrence prediction;
matching each of the recorded past expression patterns with each expression pattern selected from the plurality of expression patterns; and
predicting the trouble occurrence probability of the project based on time-series data associated with the past expression patterns, in response to matching the past expression patterns and the expression patterns.

7. The method according to claim 6, further comprising:
calculating a plurality of past trouble occurrence probabilities corresponding to the plurality of the past expression patterns, by statistically processing time when a trouble occurs in each of the past projects and a frequency of the past expression pattern associated with the trouble occurrence; and
storing the plurality of past trouble occurrence probabilities corresponding to the plurality of the past expression patterns.

8. The method according to claim 7, wherein the calculating comprises:
computing the plurality of past trouble occurrence probabilities by use of a cumulative histogram of trouble occurrences, the cumulative histogram being normalized over the trouble occurrences in the past projects, and trouble occurrence time for each of the past expression patterns.

9. The method according to claim 6, wherein the predicting comprises:
computing the trouble occurrence probability of the project by determining a starting point of the time-series data associated with the expression pattern, based on starting time of the project as the target for prediction of the trouble occurrence.

10. The method according to claim 6, wherein, the predicting comprises:
computing the trouble occurrence probability of the project by use of the largest past trouble occurrence probability selected from the set of past trouble occurrence probabilities associated with the matched past expression patterns.

11. A method for estimating a trouble occurrence probability in a project, the method comprising:
retrieving a plurality of past expression patterns associated with each trouble occurrence in the project by performing syntactic analysis on text describing states of a plurality of past projects;
storing the plurality of past expression patterns; and
recording, for each of the past expression patterns, the number of trouble occurrences in a time-series manner based on the states of the plurality of past projects.

12. The method according to claim 11, further comprising:
calculating a plurality of past trouble occurrence probabilities corresponding to the plurality of the past expression patterns, by statistically processing time when a trouble occurs in each of the past projects and a frequency of the past expression pattern associated with the trouble occurrence; and
storing the plurality of past trouble occurrence probabilities.

13. The method according to claim 12, wherein the calculating comprises:
computing the plurality of past trouble occurrence probabilities by use of a cumulative histogram of the trouble occurrences, the cumulative histogram being normalized over the trouble occurrences in the past projects and trouble occurrence time for each of the past expression patterns.

14. The method according to claim 12, further comprising:
extracting a plurality of expression patterns by performing syntactic analysis on a text describing a state of a project as a target for prediction of trouble occurrence of the project;
matching each of the recorded past expression patterns with each of the expression patterns retrieved from the text describing the state of the project; and
predicting the trouble occurrence probability of the project based on time-series data associated with the past expression patterns, in response to matching the past expression patterns and the expression patterns.

15. The method according to claim 14, wherein the predicting comprises:
computing the trouble occurrence probability of the project, by determining a starting point of the time-series data associated with the expression pattern, based on starting time of the project as the target for prediction of the trouble occurrence.

16. The method according to claim 14, wherein the predicting comprises:
computing the trouble occurrence probability of the project, by use of the largest past trouble occurrence probability selected from the set of past trouble occurrence probabilities associated with the matched past expression patterns.

17. A system for estimating a trouble occurrence probability in a project by computer processing, the system comprising:
a processor for retrieving a plurality of past expression patterns associated with trouble occurrence by performing syntactic analysis on text describing states of a plurality of past projects;
the processor for storing the plurality of past expression patterns;
the processor for calculating corresponding past trouble occurrence probabilities of the plurality of past expression patterns, by statistically processing time when a trouble occurs in each of the past projects and a frequency of the past expression pattern associated with the trouble occurrence;
the processor for storing the plurality of past trouble occurrence probabilities;
the processor for recording, for each of the past expression patterns, the number of trouble occurrences in a time-series manner based on the states of the plurality of past projects;
the processor for extracting a plurality of expression patterns by performing syntactic analysis on a text describing a state of a project as a target for prediction of the trouble occurrence;
the processor for matching each of the recorded past expression patterns with each of the expression patterns retrieved from the text describing the state of the project; and
the processor for predicting the trouble occurrence probability of the project based on time-series data associated with the past expression patterns, in response to matching the past expression patterns and the expression patterns.

18. The system according to claim 17, wherein the processor for predicting is configured to predict the trouble occurrence probability of the project by determining a starting point of the time-series data associated with the expression pattern based on starting time of the project as the target for prediction of the trouble occurrence.

19. The system according to claim 18, wherein the processor for predicting is configured to predict the trouble occurrence probability of the project by use of the largest past trouble occurrence probability selected from the set of past trouble occurrence probabilities associated with the matched past expression patterns.
